(19) United States
(12) Patent Application Publication
(10) Pub. No.: US 2025/0240621 A1
(43) Pub. Date: Jul. 24, 2025

(54) COMMUNICATING AND STORING AERIAL SYSTEM SECURITY INFORMATION

(71) Applicant: Lenovo (Singapore) Pte. Ltd., New Tech Park (SG)

(72) Inventors: Sheeba Backia Mary Baskaran, Friedrichsdorf (DE); Dimitrios Karampatsis, Ruislip (GB); Roozbeh Atarius, La Jolla, CA (US); Andreas Kunz, Ladenburg (DE)

(21) Appl. No.: 18/705,366

(22) PCT Filed: Dec. 9, 2021
(86) PCT No.: PCT/EP2021/085102

§ 371 Date: Apr. 26, 2024

(30) Foreign Application Priority Data
Oct. 26, 2021 (GR) 20210100736

(51) Int. Cl. H04W 12/06; H04W 12/72; H04W 48/16; H04W 84/06

(52) U.S. Cl. CPC H04W 12/06; H04W 12/72; H04W 84/06; H04W 48/16

(57) ABSTRACT

Apparatuses, methods, and systems are disclosed for communicating and storing aerial system security information. One method includes transmitting a request message to an uncrewed aerial system network function, a network exposure function, or a combination thereof, the request message including: an aerial vehicle identifier; a general public subscription identifier; and security policy information. The method includes receiving a response message from the uncrewed aerial system network function, the network exposure function, or the combination thereof, the response message including: the aerial vehicle identifier; the general public subscription identifier; an aerial vehicle authentication result, authorization result, or a combination thereof; and aerial system security requirement information. The method includes storing the aerial system security requirement information together with the aerial vehicle identifier, the general public subscription identifier, and the aerial vehicle authentication result.

### FIELD

The subject matter disclosed herein relates generally to wireless communications and more particularly relates to communicating and storing aerial system security information.

### BACKGROUND

In certain wireless communications networks, different network devices may not be aware of when authentication is completed by another network device in the system. In such networks, may waste data transmission and/or time.

### BRIEF SUMMARY

Methods for communicating and storing aerial system security information are disclosed. Apparatuses and systems also perform the functions of the methods. One embodiment of a method includes transmitting, from an access and mobility management function, a request message to an uncrewed aerial system network function, a network exposure function, or a combination thereof, the request message including: an aerial vehicle identifier, a general public subscription identifier; and security policy information. In some embodiments, the method includes receiving a response message from the uncrewed aerial system network function, the network exposure function, or the combination thereof, the response message including: the aerial vehicle identifier; the general public subscription identifier; an aerial vehicle authentication result, authorization result, or a combination thereof; and aerial system security requirement information. In certain embodiments, the method includes storing the aerial system security requirement information together with the aerial vehicle identifier, the general public subscription identifier, and the aerial vehicle authentication result.

One apparatus for communicating and storing aerial system security information includes an access and mobility management function. In some embodiments, the apparatus includes a transmitter that transmits a request message to an uncrewed aerial system network function, a network exposure function, or a combination thereof, the request message including: an aerial vehicle identifier; a general public subscription identifier; and security policy information. In various embodiments, the apparatus includes a receiver that receives a response message from the uncrewed aerial system network function, the network exposure function, or the combination thereof, the response message including: the aerial vehicle identifier; the general public subscription identifier; an aerial vehicle authentication result, authorization result, or a combination thereof; and aerial system security requirement information. In certain embodiments, the apparatus includes a processor that stores the aerial system security requirement information together with the aerial vehicle identifier, the general public subscription identifier, and the aerial vehicle authentication result.

Another embodiment of a method for communicating and storing aerial system security information includes receiving, at an uncrewed aerial system network function, a network exposure function, or a combination thereof, a first request message from an access and mobility management function, the first request message including: an aerial vehicle identifier; a general public subscription identifier; and security policy information. In some embodiments, the method includes transmitting a second request message to an uncrewed aerial system service supplier, an uncrewed aerial system traffic management function, or a combination thereof, the second request message including: the aerial vehicle identifier; the general public subscription identifier; and the security policy information. In certain embodiments, the method includes receiving a second response message from the uncrewed aerial system service supplier, the uncrewed aerial system traffic management function, or the combination thereof, the second response message including: the aerial vehicle identifier; the general public subscription identifier; an aerial vehicle authentication result; and aerial system security requirement information. In various embodiments, the method includes transmitting a first response message to the access and mobility management function, the first response message including: the aerial vehicle identifier; the general public subscription identifier; the aerial vehicle authentication result; and the aerial system security requirement information. In some embodiments, the method includes storing the aerial system security requirement information together with the aerial vehicle identifier, the general public subscription identifier, and the aerial vehicle authentication result.

Another apparatus for communicating and storing aerial system security information includes an uncrewed aerial system network function, a network exposure function, or a combination thereof. In some embodiments, the apparatus includes a receiver that receives a first request message from an access and mobility management function, the first request message including: an aerial vehicle identifier; a general public subscription identifier; and security policy information. In various embodiments, the apparatus includes a transmitter that transmits a second request message to an uncrewed aerial system service supplier, an uncrewed aerial system traffic management function, or a combination thereof, the second request message including: the aerial vehicle identifier; the general public subscription identifier; and the security policy information. In certain embodiments, the apparatus includes a processor. The receiver receives a second response message from the uncrewed aerial system service supplier, the uncrewed aerial system traffic management function, or the combination thereof, the second response message including: the aerial vehicle identifier; the general public subscription identifier; an aerial vehicle authentication result; and aerial system security requirement information; the transmitter transmits a first response message to the access and mobility management function, the first response message comprising: the aerial vehicle identifier; the general public subscription identifier; the aerial vehicle authentication result; and the aerial system security requirement information; and the processor stores the aerial system security requirement information together with the aerial vehicle identifier, the general public subscription identifier, and the aerial vehicle authentication result.

A further embodiment of a method for communicating and storing aerial system security information includes transmitting, from a session management function, a third request message to an uncrewed aerial system network function, a network exposure function, or a combination thereof, the third request message including: an aerial vehicle identifier; a general public subscription identifier; and a data request indication. In some embodiments, the method includes receiving a third response message from the uncrewed aerial system network function, the network exposure function, or the combination thereof, the third response message including: the aerial vehicle identifier; the general public subscription identifier; an aerial vehicle authentication result; and aerial system security requirement information. In certain embodiments, the method includes, in response to receiving the aerial vehicle authentication result, determining to establish a protocol data unit session and skipping aerial vehicle authentication. In various embodiments, the method includes storing the aerial system security requirement information together with the aerial vehicle identifier, the general public subscription identifier, the aerial vehicle authentication result, and the aerial system security requirement information. In some embodiments, the method includes applying user plane security based on the aerial system security requirement information.

A further apparatus for communicating and storing aerial system security information includes a session management function. In some embodiments, the apparatus includes a transmitter that transmits a third request message to an uncrewed aerial system network function, a network exposure function, or a combination thereof, the third request message including: an aerial vehicle identifier; a general public subscription identifier; and a data request indication. In various embodiments, the apparatus includes a receiver that receives a third response message from the uncrewed aerial system network function, the network exposure function, or the combination thereof, the third response message including: the aerial vehicle identifier; the general public subscription identifier; an aerial vehicle authentication result; and aerial system security requirement information. In certain embodiments, the apparatus includes a processor that: in response to receiving the aerial vehicle authentication result, determines to establish a protocol data unit session and skipping aerial vehicle authentication; stores the aerial system security requirement information together with the aerial vehicle identifier, the general public subscription identifier, the aerial vehicle authentication result, and the aerial system security requirement information; and applies user plane security based on the aerial system security requirement information.

Another embodiment of a method for communicating and storing aerial system security information includes receiving, at an uncrewed aerial system service supplier, an uncrewed aerial system traffic management function, or a combination thereof, a request message from an uncrewed aerial system network function, a network exposure function, or a combination thereof, the request message including: an aerial vehicle identifier; a general public subscription identifier; and security policy information. In some embodiments, the method includes transmitting a response message to the uncrewed aerial system network function, the network exposure function, or the combination thereof, the response message including: the aerial vehicle identifier; the general public subscription identifier; an aerial vehicle authentication result; and aerial system security requirement information. In certain embodiments, the method includes storing the aerial system security requirement information together with the aerial vehicle identifier, the general public subscription identifier, and the aerial vehicle authentication result.

Another apparatus for communicating and storing aerial system security information includes an uncrewed aerial system service supplier, an uncrewed aerial system traffic management function, or a combination thereof. In some embodiments, the apparatus includes a receiver that receives a request message from an uncrewed aerial system network function, a network exposure function, or a combination thereof, the request message including: an aerial vehicle identifier; a general public subscription identifier; and security policy information. In various embodiments, the apparatus includes a transmitter that transmits a response message to the uncrewed aerial system network function, the network exposure function, or the combination thereof, the response message including: the aerial vehicle identifier; the general public subscription identifier; an aerial vehicle authentication result; and aerial system security requirement information. In certain embodiments, the apparatus includes a processor that stores the aerial system security requirement information together with the aerial vehicle identifier, the general public subscription identifier, and the aerial vehicle authentication result.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for communicating and storing aerial system security information;

FIG. 2 is a schematic block diagram illustrating one embodiment of an apparatus that may be used for communicating and storing aerial system security information;

FIG. 3 is a schematic block diagram illustrating one embodiment of an apparatus that may be used for communicating and storing aerial system security information;

FIG. 4 is a schematic block diagram illustrating one embodiment of a system for user plane security requirement retrieval from a USS and/or UTM;

FIG. 5 is a schematic block diagram illustrating one embodiment of a system for providing a UUAA result and UAS security requirement information to an SMF;

FIG. 6 is a flow chart diagram illustrating one embodiment of a method for communicating and storing aerial system security information;

FIG. 7 is a flow chart diagram illustrating another embodiment of a method for communicating and storing aerial system security information;

FIG. 8 is a flow chart diagram illustrating a further embodiment of a method for communicating and storing aerial system security information; and

FIG. 9 is a flow chart diagram illustrating yet another embodiment of a method for communicating and storing aerial system security information.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

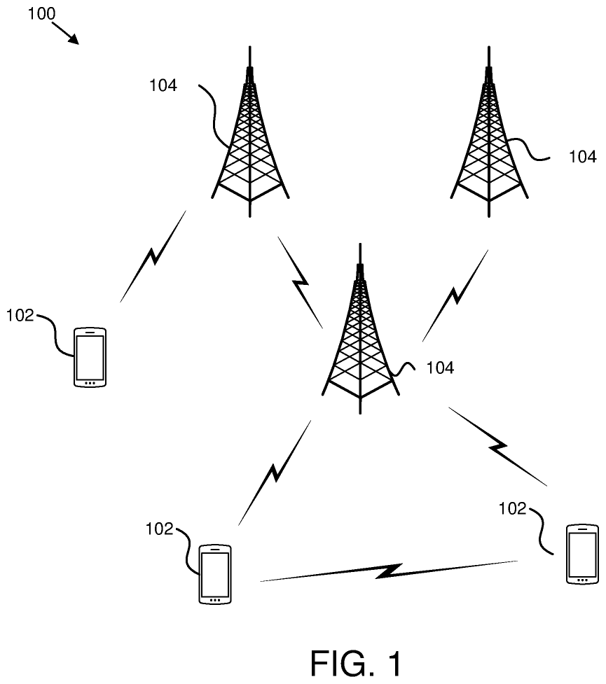

FIG. 1 depicts an embodiment of a wireless communication system 100 for communicating and storing aerial system security information. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), a Uncrewed Aerial System Network Function (“UAS NF”), an Network Exposure Function (“NEF”), a UAS Service Supplier (“USS”), a Uncrewed Aerial System Traffic Management (“UTM”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may transmit a request message to an uncrewed aerial system network function, a network exposure function, or a combination thereof, the request message including: an aerial vehicle identifier; a general public subscription identifier; and security policy information. In some embodiments, the network unit 104 may receive a response message from the uncrewed aerial system network function, the network exposure function, or the combination thereof, the response message including: the aerial vehicle identifier; the general public subscription identifier; an aerial vehicle authentication result, authorization result, or a combination thereof, and aerial system security requirement information. In certain embodiments, the network unit 104 may store the aerial system security requirement information together with the aerial vehicle identifier, the general public subscription identifier, and the aerial vehicle authentication result. Accordingly, the network unit 104 may be used for communicating and storing aerial system security information.

In certain embodiments, a network unit 104 may receive a network exposure function, or a combination thereof, a first request message from an access and mobility management function, the first request message including: an aerial vehicle identifier; a general public subscription identifier; and security policy information. In some embodiments, the network unit 104 may transmit a second request message to an uncrewed aerial system service supplier, an uncrewed aerial system traffic management function, or a combination thereof, the second request message including: the aerial vehicle identifier; the general public subscription identifier; and the security policy information. In certain embodiments, the network unit 104 may receive a second response message from the uncrewed aerial system service supplier, the uncrewed aerial system traffic management function, or the combination thereof, the second response message including: the aerial vehicle identifier; the general public subscription identifier; an aerial vehicle authentication result; and aerial system security requirement information. In various embodiments, the network unit 104 may transmit a first response message to the access and mobility management function, the first response message including: the aerial vehicle identifier; the general public subscription identifier; the aerial vehicle authentication result; and the aerial system security requirement information. In some embodiments, the network unit 104 may store the aerial system security requirement information together with the aerial vehicle identifier, the general public subscription identifier, and the aerial vehicle authentication result. Accordingly, the network unit 104 may be used for communicating and storing aerial system security information.

In some embodiments, a network unit 104 may transmit a third request message to an uncrewed aerial system network function, a network exposure function, or a combination thereof, the third request message including: an aerial vehicle identifier; a general public subscription identifier; and a data request indication. In some embodiments, the network unit 104 may receive a third response message from the uncrewed aerial system network function, the network exposure function, or the combination thereof, the third response message including: the aerial vehicle identifier; the general public subscription identifier; an aerial vehicle authentication result; and aerial system security requirement information. In certain embodiments, the network unit 104 may, in response to receiving the aerial vehicle authentication result, determine to establish a protocol data unit session and skipping aerial vehicle authentication. In various embodiments, the network unit 104 may store the aerial system security requirement information together with the aerial vehicle identifier, the general public subscription identifier, the aerial vehicle authentication result, and the aerial system security requirement information. In some embodiments, the network unit 104 may apply user plane security based on the aerial system security requirement information. Accordingly, the network unit 104 may be used for communicating and storing aerial system security information.

In various embodiments, a network unit 104 may receive an uncrewed aerial system traffic management function, or a combination thereof, a request message from an uncrewed aerial system network function, a network exposure function, or a combination thereof, the request message including: an aerial vehicle identifier; a general public subscription identifier; and security policy information. In some embodiments, the network unit 104 may transmit a response message to the uncrewed aerial system network function, the network exposure function, or the combination thereof, the response message including: the aerial vehicle identifier; the general public subscription identifier; an aerial vehicle authentication result; and aerial system security requirement information. In certain embodiments, the network unit 104 may store the aerial system security requirement information together with the aerial vehicle identifier, the general public subscription identifier, and the aerial vehicle authentication result. Accordingly, the network unit 104 may be used for communicating and storing aerial system security information.

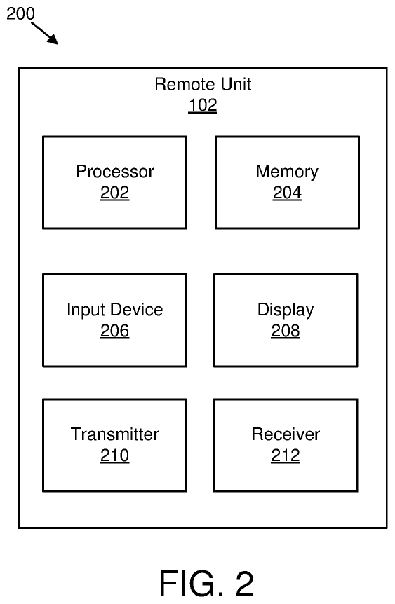

FIG. 2 depicts one embodiment of an apparatus 200 that may be used for communicating and storing aerial system security information. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

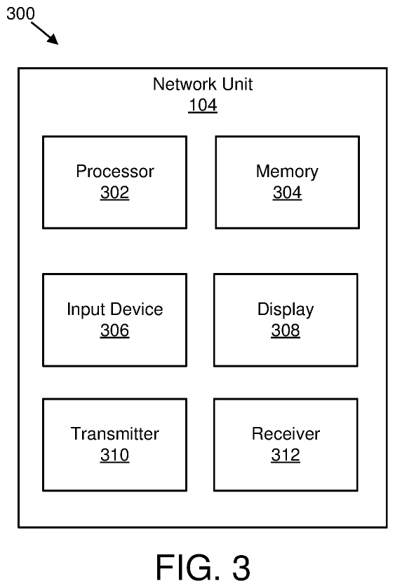

FIG. 3 depicts one embodiment of an apparatus 300 that may be used for communicating and storing aerial system security information. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 transmits a request message to an uncrewed aerial system network function, a network exposure function, or a combination thereof, the request message including: an aerial vehicle identifier; a general public subscription identifier; and security policy information. In various embodiments, the receiver 312 receives a response message from the uncrewed aerial system network function, the network exposure function, or the combination thereof, the response message including: the aerial vehicle identifier; the general public subscription identifier; an aerial vehicle authentication result, authorization result, or a combination thereof; and aerial system security requirement information. In certain embodiments, the processor 302 stores the aerial system security requirement information together with the aerial vehicle identifier, the general public subscription identifier, and the aerial vehicle authentication result.

In some embodiments, receiver 312 receives a first request message from an access and mobility management function, the first request message including: an aerial vehicle identifier; a general public subscription identifier; and security policy information. In various embodiments, the transmitter 310 transmits a second request message to an uncrewed aerial system service supplier, an uncrewed aerial system traffic management function, or a combination thereof, the second request message including: the aerial vehicle identifier; the general public subscription identifier; and the security policy information. In certain embodiments, the apparatus includes a processor 302. The receiver 312 receives a second response message from the uncrewed aerial system service supplier, the uncrewed aerial system traffic management function, or the combination thereof, the second response message including: the aerial vehicle identifier; the general public subscription identifier; an aerial vehicle authentication result; and aerial system security requirement information; the transmitter 310 transmits a first response message to the access and mobility management function, the first response message comprising: the aerial vehicle identifier; the general public subscription identifier; the aerial vehicle authentication result; and the aerial system security requirement information; and the processor 302 stores the aerial system security requirement information together with the aerial vehicle identifier, the general public subscription identifier, and the aerial vehicle authentication result.

In various embodiments, the transmitter 310 transmits a third request message to an uncrewed aerial system network function, a network exposure function, or a combination thereof, the third request message including: an aerial vehicle identifier; a general public subscription identifier; and a data request indication. In various embodiments, the receiver 312 receives a third response message from the uncrewed aerial system network function, the network exposure function, or the combination thereof, the third response message including: the aerial vehicle identifier; the general public subscription identifier; an aerial vehicle authentication result; and aerial system security requirement information. In certain embodiments, the processor 302: in response to receiving the aerial vehicle authentication result, determines to establish a protocol data unit session and skipping aerial vehicle authentication; stores the aerial system security requirement information together with the aerial vehicle identifier, the general public subscription identifier, the aerial vehicle authentication result, and the aerial system security requirement information; and applies user plane security based on the aerial system security requirement information.

In certain embodiments, the receiver 312 receives a request message from an uncrewed aerial system network function, a network exposure function, or a combination thereof, the request message including: an aerial vehicle identifier; a general public subscription identifier; and security policy information. In various embodiments, the transmitter 310 transmits a response message to the uncrewed aerial system network function, the network exposure function, or the combination thereof, the response message including: the aerial vehicle identifier; the general public subscription identifier; an aerial vehicle authentication result; and aerial system security requirement information. In certain embodiments, the processor 302 stores the aerial system security requirement information together with the aerial vehicle identifier, the general public subscription identifier, and the aerial vehicle authentication result.

In certain embodiments, an uncrewed aerial system (“UAS”) service supplier (“USS”) uncrewed aerial vehicle (“UAV”) authorization and/or authentication (“UUAA”) may be performed for a UAV during its registration to a fifth generation (“5G”) system or during a protocol data unit (“PDU”) session establishment and/or modification procedure related to a UAS service. If the UUAA is performed for a UAV during the registration, then it may not be required to perform UUAA during subsequent PDU session establishment procedure. In such embodiments, it may not be clear how a session management function (“SMF”) involved in a PDU session establishment procedure is to know whether a UUAA has been performed for the UAV or not, thus leading to various issues.

In some embodiments, an SMF can invoke additional UUAA for a UAV during a PDU session establishment procedure (e.g., without the knowledge of earlier successful UUAA) leading to a delayed UAS session set up and unnecessary overhead (e.g., inefficient resource utilization).

In various embodiments, a system may coordinate UUAA results and UUAA information (e.g., such as UAS and/or command and control (“C2”) user plane security requirement information) between a 3GPP network function (“NF”) (e.g., such as an AMF or UAS NF and/or network exposure function (“NEF”)) and SMF during PDU session establishment and/or modification procedure to allow the SMF to know whether a UUAA has been already successfully performed for a UAV or not during a recent registration procedure.

In a first embodiment, there may be service based user plane security enforcement in 3GPP 5G system (“5GS”) during UUAA. In the first embodiment, an NF in 3GPP system may receive a user plane security requirement information from a USS and/or uncrewed aerial system traffic management (“UTM”) following a successful UAS service authentication and/or authorization (e.g., UUAA or UAV and/or UAV controller (“UAV-C”) pairing authorization).

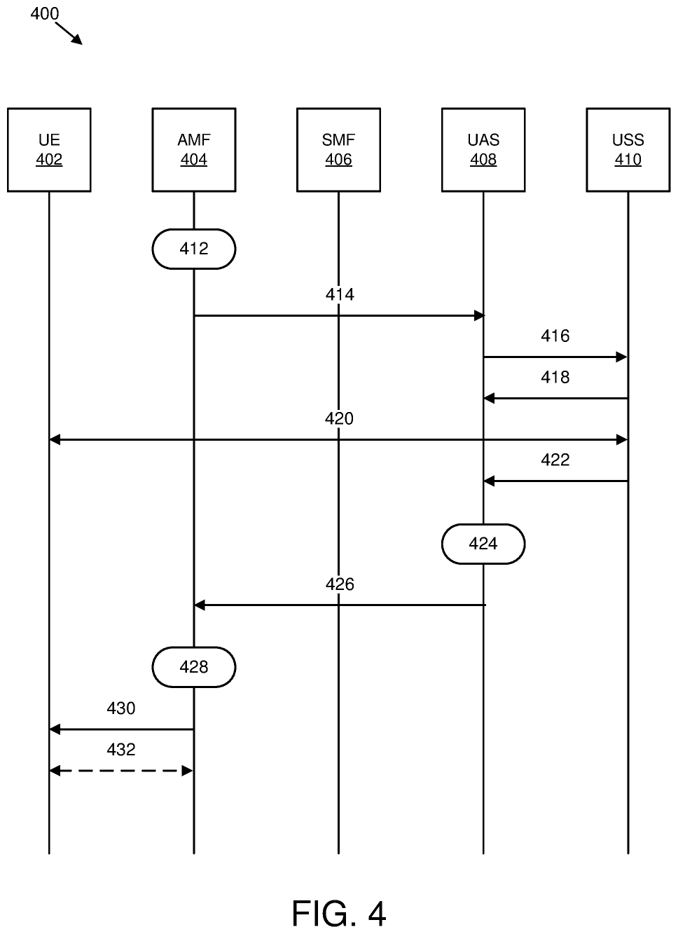

FIG. 4 is a schematic block diagram illustrating one embodiment of a system 400 for user plane security requirement retrieval from a USS and/or UTM. The system 400 includes a user equipment (“UE”) 402, an AMF 404, an SMF 406, a UAS 408 (e.g., UAS NF and/or NEF), and a USS 410 (e.g., USS and/or UTM). It should be noted that each of the communications in the system 400 may include one or more messages.

In certain embodiments, the UE 402 requests any UAS 408 service with a transmission to the AMF 404 (e.g., with its UAV identifier (“ID”)). The AMF 404 determines to trigger a UUAA based on local policy and/or the AMF 404 determines to trigger a UUAA following a request from the USS 410.

The AMF 404 invokes 412 the UUAA.

In a first communication 414, the AMF 4040 sends to the UAS 408 an authentication request (e.g., Nnef_Authentication_request) including a UAV ID (e.g., civil aviation administration (“CAA”) level UAV ID) and an external identifier (e.g., general public subscription identifier (“GPSI”)). In certain embodiments, the authentication request includes UAS session security information (e.g., security policy information). It should be noted that UAS session security information may be termed a user plane security policy, a UAS security policy, and/or an external UAS security policy. The UAS session security information and/or UAS security policy may also include policies specific to user plane confidentiality and user plane integrity protection.

In a second communication 416, the UAS 408 may send to the USS 410, an authentication request (e.g., Naf_Authentication_request) including the UAV ID (e.g., CAA level UAV ID) and the external identifier (e.g., GPSI). In some embodiments, the authentication request may include also the UAS session security information.

In various embodiments, the AMF 404 may set the session security information as “supported” based on any of the following conditions: 1) if an aerial subscription user plane security policy fetched from a UDM is ‘required’; and/or 2) if a user plane security policy fetched from the UDM is ‘required’.

In certain embodiments, the AMF 404 may set the session security information as “not-supported, not preferred, and/or not required” based on any of the following conditions: 1) if there is no aerial subscription; and/or 2) if a user plane security policy fetched from the UDM is “not needed and/or not preferred”.

In a third communication 418, the USS 410 may send to the UAS 408 an authentication response (e.g., Naf_Authentication_response) including the external identifier (e.g., GPSI) and an authentication and/or authorization message.

In an optional fourth communication 420, multiple round-trip messages as required by an authentication method used by the USS 410 may be performed. Authentication and/or authenticate response messages from the USS 410 may include GPSI and may include an authentication message based on an authentication method used that is forwarded transparently to the UE 402 over transport messages (e.g., mobility management messages).

In a fifth communication 422, following a successful authentication and/or authorization, the USS 410 may send to the UAS 408 an authentication response (e.g., Naf_Authentication_response) including the external identifier (e.g., GPSI), the CAA-Level UAV ID, a result and UAS security requirement information (e.g., it may be user plane security requirement information).

In some embodiments, the USS 410 sets the UAS security requirement information as “required” based on at least one of the following conditions: 1) if the USS 410 received session security information from the UAS 408 in step 416 is “supported”; and/or 2) if the USS 410 determines not to apply end-to-end security for the session and/or user plane data. In various embodiments, a cause value may be sent from the USS 410 which indicates that end-to-end security is not applicable and/or not supported.

In certain embodiments, the USS 410 sets the UAS security requirement information as “not required” based on at least one of the following conditions: 1) if the USS 410 received session security information from the UAS 408 in step 422 is “not needed and/or not preferred”; 2) if the USS 410 receives no UAS session security information in step 416; and/or 3) if the USS 410 determines to apply end-to-end security for the session and/or user plane data. In some embodiments, a cause value can be sent from the USS 410 which indicates end-to-end security is applicable and/or supported.

In some embodiments, if the USS 410 received session security information as “supported” from the UAS 408 in step 416, then the USS 410 may determine to skip end-to-end security and may set the UAS session security requirement information as “required”, and a cause value as end-to-end security not applicable and/or not supported.

In various embodiments, if the USS 410 received session security information as “not supported, not preferred, and/or not required” from the UAS 408 in step 416, then the USS 410 may determine to perform end-to-end security and may set the UAS session security requirement information as “not required”, and a cause value as end-to-end security is applicable and/or supported.

The UAS 408 may store 424 the received UAS security requirement information (e.g., it may be user plane security requirement information) along with the external identifier (e.g., GPSI), the CAA-Level UAV ID, and/or the result.

In a sixth communication 426, the UAS 408 may send to the AMF 404 an authentication response message including UAS security requirement information (e.g., it may be user plane security requirement information) along with the external identifier (e.g., GPSI), the CAA-Level UAV ID, and/or the result.

The AMF 404 may store 428 the received UAS security requirement information (e.g., it may be user plane security requirement information) along with the external identifier (e.g., GPSI), the CAA-Level UAV ID, and/or the result.

In a seventh communication 430 and/or an optional eighth communication 432, the AMF 404 may provide the authentication result and CAA-level UAV ID to the UE 402 in a non-access stratum (“NAS”) message (e.g., mobility management message or any UE configuration update message).

In a second embodiment, there may be UUAA status coordination in 3GPP 5GS. In the second embodiment, the UUAA may be performed for a UAV during its registration to the 5G system or during a PDU session establishment and/or modification procedure. If the UUAA is performed for a UAV during the registration, then it is not required to perform UUAA during a subsequent PDU session establishment procedure. In some embodiments, the SMF involved in the PDU session establishment may have no means to know whether a UUAA has been successfully performed or not previously for a corresponding UAV. The second embodiment includes information about how an SMF is informed about a successful UUAA result during a subsequent PDU session establishment procedure if a UUAA has been performed successfully earlier during the registration.

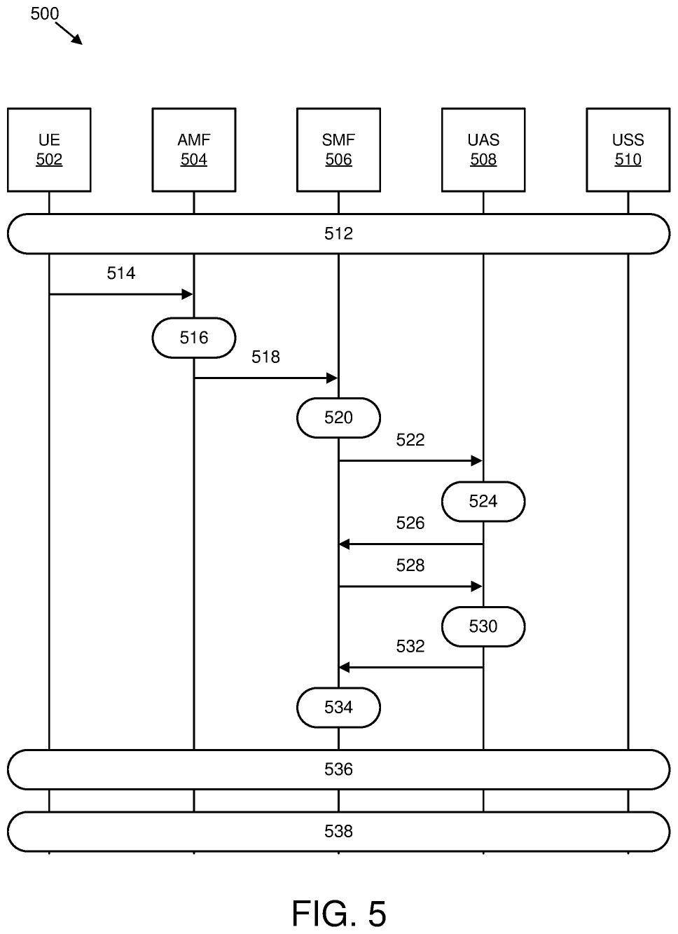

FIG. 5 is a schematic block diagram illustrating one embodiment of a system 500 for providing a UUAA result and UAS security requirement information to an SMF. The system 500 includes a UE 502, an AMF 504, an SMF 506, a UAS 508 (e.g., UAS NF and/or NEF), and a USS 510 (e.g., USS and/or UTM). It should be noted that each of the communications in the system 500 may include one or more messages.

FIG. 5 includes three options to provide UUAA results and UUAA information (e.g., such as UAS and/or C2 user plane security requirement information) to the SMF 506 to allow the SMF to continue with a PDU session establishment procedure without an additional UUAA.

In a first communication 512, a successful UUAA is performed for a UAV during a 5GS registration procedure and an NF (e.g., the AMF 504, the UAS 508) in the 3GPP network has stored the UUAA results (e.g., along with the UAV ID) and UAS security requirement information (or user plane security requirement information) either in a local storage or in a unstructured data storage function (“UDSF”) and/or UDM. It should be noted that UAS security requirement information storage may be the same as described in the first embodiment. UAS Security requirement information may indicate if a user plane security (or UAS session and/or C2 session security) need to be applied by the 5GS.

UAS security requirement information may contain the following information: 1) 3GPP user plane security indicated as “required” and a cause value may indicate that end-to-end security is not applicable and/or not supported as enforced by the USS 510; or 2) 3GPP user plane security indicated as “not required” and a cause value may indicate that end-to-end security is applicable and/or supported as enforced by the USS 510.

A first option includes steps 514, 516, 518, 520, 536, and 538.

Specifically, in a second communication 514, the UE 502 sends to the AMF 504 a PDU session establishment request in a NAS message which includes a service level device identity (e.g., the CAA-Level UAV ID of the UAV) and optionally authentication data (e.g., a UUAA aviation payload).

The AMF 504, based on the received CAA-level UAV ID, if it finds a UE context with UUAA information such as UUAA result and UAS security requirement information locally stored, then the AMF 504 determines 516 to provide the UUAA information to the SMF 506. The AMF 504 selects the SMF 506 and, in a third communication 518, sends a Nsmf_PDUSession_CreateSMContext request message along with the PDU session establishment request, UUAA result (e.g., with success indication), and/or UAS security requirement embodiments, the AMF 504 may send a information. In certain Nsmf_PDUSession_UpdateSMContext request message to the SMF 506 which may include a UUAA result (e.g., with success indication) and/or UAS security requirement information.

The SMF 506, on receiving the CAA-level UAV ID with UUAA result (e.g., with success indication) and/or the UAS security requirement information, determines 520 to continue with the PDU session establishment procedure without performing any additional UUAA with the USS 510 as the UUAA result (e.g., with success indication) and/or the UAS security requirement information from the registration procedure is available for the SMF 506 to continue with the PDU session establishment related to the UAS service.

In the first option, steps 522 through 534 may be skipped. In an eighth communication 536, the SMF 506 continues with a PDU session establishment procedure and/or a modification procedure. In a ninth communication 538, if no UUAA result is provided by the AMF 504, the SMF 506 triggers to perform UUAA with the USS 510 for the PDU session establishment and/or modification procedure.

A second option includes steps 514, 518, 522, 524, 526, 534, 536, and 538—accordingly, steps 516, 520, and 528 to 532 are skipped.

In the second communication 514, the UE 502 sends to the AMF 504 a PDU session establishment request in an NAS message which includes a service level device identity (e.g., the CAA-Level UAV ID of the UAV) and optionally authentication data (e.g., the UUAA aviation payload).

In the third communication 518, the AMF 504 selects the SMF 506 and sends to the SMF 506 a Nsmf_PDUSession_CreateSMContext request message along with a PDU session establishment request.

In a fourth communication 522, the SMF 506 determines to check for the CAA-Level-UAV ID and/or external identifier (e.g., GPSI) if there exists any UUAA result from the recent UUAA. Further, the SMF 506 sends to the UAS 508 a data request message (e.g., Nnef_Auth_Data Request or Nnef_UUAA_Data Request) including the CAA level UAV ID and/or the external identifier (e.g., GPSI).

The UAS 508, based on the received CAA-level UAV ID, if it finds a UE context with UUAA information such as UUAA result and UAS security requirement information locally stored, then the UAS 508 determines 524 to provide the UUAA information to the SMF 506.

In a fifth communication 526, the UAS 508 sends to the SMF 506 a data response message (e.g., Nnef_Auth_Data Response or Nnef_UUAA_Data Response) including the CAA level UAV ID and/or the external identifier (e.g., GPSI), the UUAA result (e.g., with success indication), and/or UAS security requirement information. In some embodiments, if no UUAA results are available, then the UAS 508 sends to the SMF 506 a data response message (e.g., Nnef_Auth_Data Response or Nnef_UUAA_Data Response) including the CAA level UAV ID and/or the external identifier (e.g., GPSI), and/or data not available indication.

The SMF 506, on receiving the CAA-level UAV ID with UUAA result (e.g., with success indication), and/or the UAS security requirement information, determines 534 to continue with the PDU session establishment procedure without performing any additional UUAA with the USS 510 as the UUAA result (e.g., with success indication), and UAS security requirement information from the registration procedure is available for the SMF 506 to continue with the PDU session establishment related to the UAS service.

In the eighth communication 536, the SMF 506 continues with the PDU session establishment procedure and/or modification procedure. In various embodiments, if no UUAA result is provided, a data not available indication may be provided by the UAS 508, then in the optional ninth communication 538, the SMF 506 triggers to perform UUAA with the USS 510 for the PDU session establishment and/or modification procedure.

A third option includes steps 514, 518, 528, 530, 532, 534, 536, and 538—accordingly, steps 516 and 520 to 526 are skipped.

In the second communication 514, the UE 502 sends to the AMF 504 a PDU session establishment request in an NAS message which includes a service level device identity (e.g. the CAA-Level UAV ID of the UAV) and optionally authentication data (e.g., the UUAA aviation payload).

In the third communication 518, the AMF 504 selects the SMF 506 and sends to the SMF 506 a Nsmf_PDUSession_CreateSMContext request message along with a PDU session establishment request.

In a sixth communication 528, the SMF 506 determines to invoke UUAA and sends to the UAS 508 an authentication request message (e.g., Nnef_Auth_Request) including the CAA level UAV ID and the external identifier (e.g., GPSI).

The UAS 508, based on the received CAA-level UAV ID, if it finds a UE context with UUAA information such as UUAA result and UAS security requirement information locally stored, then the UAS 508 determines 530 to provide the UUAA information to the SMF 506.

In a seventh communication 532, the UAS 508 sends to the SMF 506 an authentication response message (e.g., Nnef_Auth_Response) including the CAA level UAV ID and/or the external identifier (e.g., GPSI), the UUAA result (e.g., with success indication), and/or the UAS security requirement information.

The SMF 506, on receiving the CAA-level UAV ID and/or the external identifier (e.g., GPSI), with the UUAA result (e.g., with success indication), and/or the UAS security requirement information, determines 534 to continue with the PDU session establishment procedure without performing any additional UUAA with the USS 510 as the UUAA result (e.g., with success indication), and/or the UAS security requirement information from the registration procedure is available for the SMF 506 to continue with the PDU session establishment related to the UAS service.

In the eighth communication 536, the SMF 506 continues with the PDU session establishment procedure and/or modification procedure. In various embodiments, if no UUAA result is provided, a data not available indication may be provided by the UAS 508, then in the optional ninth communication 538, the SMF 506 triggers to perform UUAA with the USS 510 for the PDU session establishment and/or modification procedure.

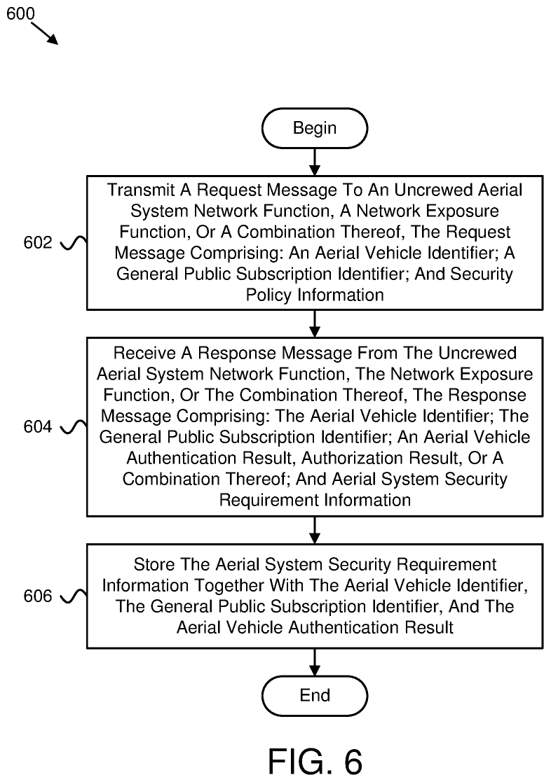

FIG. 6 is a flow chart diagram illustrating one embodiment of a method 600 for communicating and storing aerial system security information. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602 a request message to an uncrewed aerial system network function, a network exposure function, or a combination thereof, the request message including: an aerial vehicle identifier; a general public subscription identifier; and security policy information. In some embodiments, the method 600 includes receiving 604 a response message from the uncrewed aerial system network function, the network exposure function, or the combination thereof, the response message including: the aerial vehicle identifier; the general public subscription identifier; an aerial vehicle authentication result, authorization result, or a combination thereof; and aerial system security requirement information. In certain embodiments, the method 600 includes storing 606 the aerial system security requirement information together with the aerial vehicle identifier, the general public subscription identifier, and the aerial vehicle authentication result.

In certain embodiments, the method 600 further comprises setting the security policy information to supported, enabled, or a combination thereof in response to an aerial subscription user plane security policy fetched from a management function (i.e., unified data management function (UDM)) being required, in response to a user plane security policy fetched from the management function (i.e., unified data management function (UDM)) being required, or a combination thereof.

In some embodiments, the method 600 further comprises setting the security policy information to not supported, not enabled, not preferred, not needed, or a combination thereof in response to there being no aerial subscription available for an aerial vehicle corresponding to the aerial vehicle identifier, in response to a user plane security policy fetched from a management function (i.e., unified data management function (UDM)) being preferred, not needed, or a combination thereof.

In various embodiments, the method 600 further comprises providing the aerial vehicle authentication result during a protocol data unit session establishment procedure and the aerial system security requirement information along with the aerial vehicle identifier to a session management function in response to receiving a protocol data unit session establishment request from a user equipment with the aerial vehicle identifier.

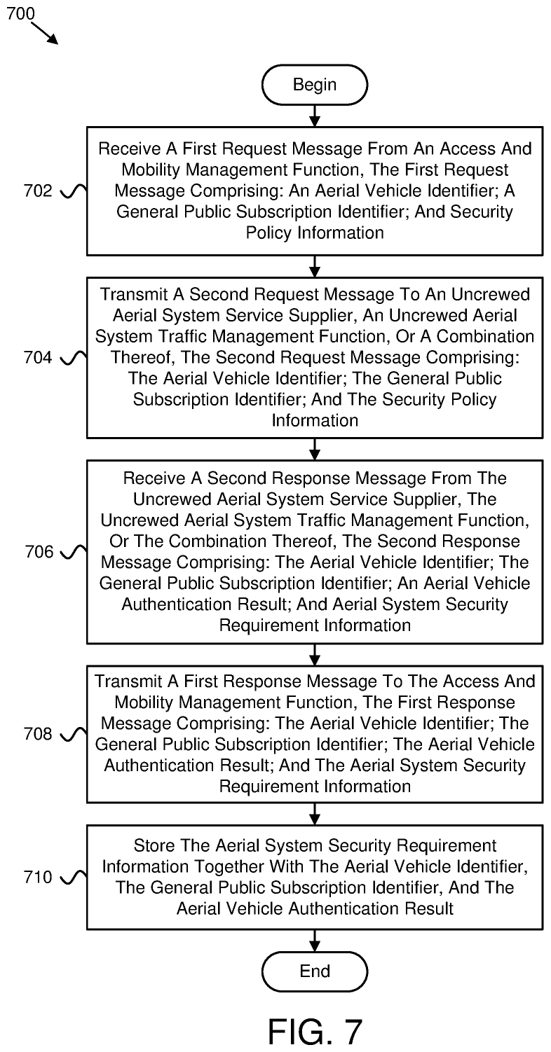

FIG. 7 is a flow chart diagram illustrating another embodiment of a method 700 for communicating and storing aerial system security information. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702 a first request message from an access and mobility management function, the first request message including: an aerial vehicle identifier; a general public subscription identifier; and security policy information. In some embodiments, the method 700 includes transmitting 704 a second request message to an uncrewed aerial system service supplier, an uncrewed aerial system traffic management function, or a combination thereof, the second request message including: the aerial vehicle identifier; the general public subscription identifier; and the security policy information. In certain embodiments, the method 700 includes receiving 706 a second response message from the uncrewed aerial system service supplier, the uncrewed aerial system traffic management function, or the combination thereof, the second response message including: the aerial vehicle identifier; the general public subscription identifier; an aerial vehicle authentication result; and aerial system security requirement information. In various embodiments, the method 700 includes transmitting 708 a first response message to the access and mobility management function, the first response message including: the aerial vehicle identifier; the general public subscription identifier; the aerial vehicle authentication result; and the aerial system security requirement information. In some embodiments, the method 700 includes storing 710 the aerial system security requirement information together with the aerial vehicle identifier, the general public subscription identifier, and the aerial vehicle authentication result.

In certain embodiments, the method 700 further comprises providing the aerial vehicle authentication result during a protocol data unit session establishment procedure and the aerial system security requirement information along with the aerial vehicle identifier to a session management function in response to receiving an authentication request from the session management function.

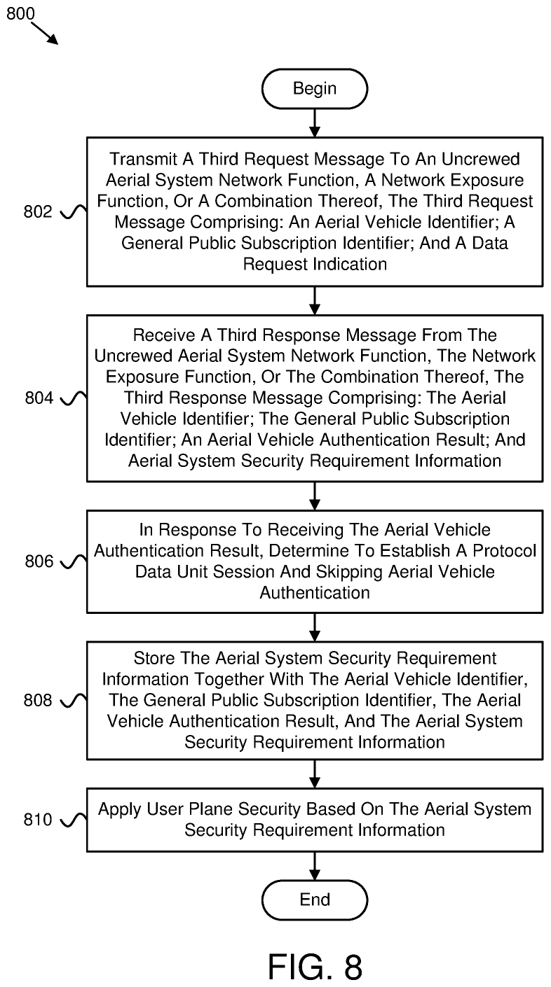

FIG. 8 is a flow chart diagram illustrating a further embodiment of a method 800 for communicating and storing aerial system security information. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes transmitting 802 a third request message to an uncrewed aerial system network function, a network exposure function, or a combination thereof, the third request message including: an aerial vehicle identifier; a general public subscription identifier; and a data request indication. In some embodiments, the method 800 includes receiving 804 a third response message from the uncrewed aerial system network function, the network exposure function, or the combination thereof, the third response message including: the aerial vehicle identifier; the general public subscription identifier; an aerial vehicle authentication result; and aerial system security requirement information. In certain embodiments, the method 800 includes, in response to receiving the aerial vehicle authentication result, determining 806 to establish a protocol data unit session and skipping aerial vehicle authentication. In various embodiments, the method 800 includes storing 808 the aerial system security requirement information together with the aerial vehicle identifier, the general public subscription identifier, the aerial vehicle authentication result, and the aerial system security requirement information. In some embodiments, the method 800 includes applying 810 user plane security based on the aerial system security requirement information.

In certain embodiments, the method 800 further comprises receiving the third response without sending the third request message in response to the uncrewed aerial system network function, the network exposure function, or the combination thereof comprising an access and mobility management function. In some embodiments, the method 800 further comprises receiving the third response in response to the uncrewed aerial system network function, the network exposure function, or the combination thereof comprising an access and mobility management system, the access and mobility management function receiving a protocol data unit session establishment request having the aerial vehicle identifier, and the access and mobility management system has the aerial vehicle identifier with the aerial vehicle authentication result, and the aerial system security requirement information.

In various embodiments, the third request message is an authentication data request or an authentication request message. In one embodiment, the third response message is an authentication data response or authentication response message. In certain embodiments, the third response message comprises a data not available indication. In some embodiments, the method 800 further comprises determining to invoke aerial vehicle authentication if a data not available indication is received or if no aerial vehicle authentication result and security requirement information is received from a network function.

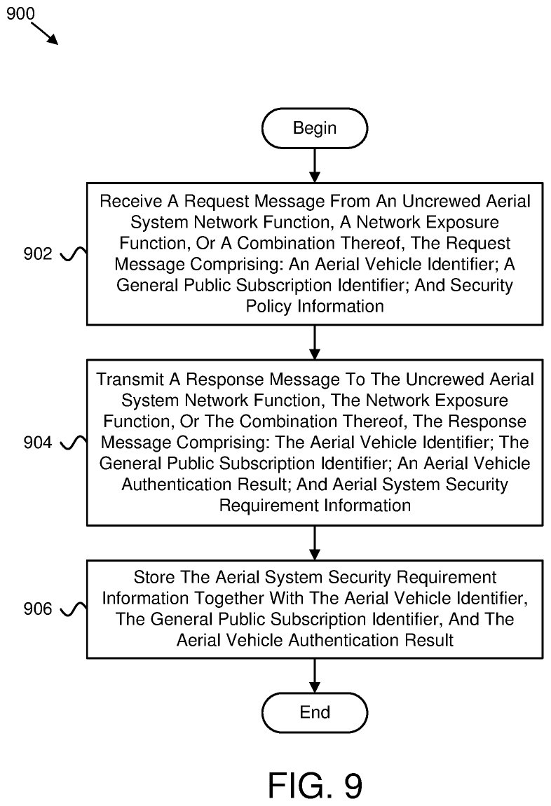

FIG. 9 is a flow chart diagram illustrating yet another embodiment of a method 900 for communicating and storing aerial system security information. In some embodiments, the method 900 is performed by an apparatus, such as the network unit 104. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902 an uncrewed aerial system traffic management function, or a combination thereof, a request message from an uncrewed aerial system network function, a network exposure function, or a combination thereof, the request message including: an aerial vehicle identifier; a general public subscription identifier; and security policy information. In some embodiments, the method 900 includes transmitting 904 a response message to the uncrewed aerial system network function, the network exposure function, or the combination thereof, the response message including: the aerial vehicle identifier; the general public subscription identifier; an aerial vehicle authentication result; and aerial system security requirement information. In certain embodiments, the method 900 includes storing 906 the aerial system security requirement information together with the aerial vehicle identifier, the general public subscription identifier, and the aerial vehicle authentication result.

In certain embodiments, the method 900 further comprises setting the aerial system security requirement information as required based on: whether the security policy information is supported, enabled, or a combination thereof received from the uncrewed aerial system network function, the network exposure function, or the combination thereof; whether an uncrewed aerial system service supplier, an uncrewed aerial system traffic management function, or a combination thereof determines not to apply end-to-end security for session data, user plane data, or a combination thereof, or a combination thereof. In some embodiments, the method 900 further comprises transmitting a cause value indicating that end-to-end security is not applicable, not supported, or a combination thereof.

In various embodiments, the method 900 further comprises setting the aerial system security requirement information as not required based on: whether the security policy information is not supported, not enabled, not needed, not preferred, or a combination thereof received from the uncrewed aerial system network function, the network exposure function, or the combination thereof; whether an uncrewed aerial system service supplier, an uncrewed aerial system traffic management function, or a combination thereof receives no security policy information during aerial vehicle authentication and/or authorization; whether the uncrewed aerial system service supplier, the uncrewed aerial system traffic management function, or the combination thereof determines to apply end-to-end security for session data, user plane data, or a combination thereof; or some combination thereof.

In one embodiment, the method 900 further comprises transmitting a cause value indicating that end-to-end security is applicable, supported or a combination thereof. In certain embodiments, if the security policy information is supported, enabled or a combination thereof is received from the uncrewed aerial system network function, the network exposure function, or the combination thereof, then an uncrewed aerial system service supplier, an uncrewed aerial system traffic management function, or a combination thereof determines to skip end-to-end security, sets the aerial system security requirement information as required, and sets a cause value as end-to-end security not applicable, not supported, or a combination thereof.

In some embodiments, if the security policy information is not supported, not enabled, not needed, not preferred, or a combination thereof is received from the uncrewed aerial system network function, the network exposure function, or the combination thereof, then an uncrewed aerial system service supplier, an uncrewed aerial system traffic management function, or a combination thereof determines to activate end-to-end security, sets the aerial system security requirement information as not required, and sets a cause value as end-to-end security being applicable, supported, or a combination thereof.

In one embodiment, a method of an access and mobility management function comprises: transmitting a request message to an uncrewed aerial system network function, a network exposure function, or a combination thereof, the request message comprising: an aerial vehicle identifier; a general public subscription identifier; and security policy information; receiving a response message from the uncrewed aerial system network function, the network exposure function, or the combination thereof, the response message comprising: the aerial vehicle identifier; the general public subscription identifier; an aerial vehicle authentication result, authorization result, or a combination thereof; and aerial system security requirement information; and storing the aerial system security requirement information together with the aerial vehicle identifier, the general public subscription identifier, and the aerial vehicle authentication result.

In certain embodiments, the method further comprises setting the security policy information to supported, enabled, or a combination thereof in response to an aerial subscription user plane security policy fetched from a management function (i.e., unified data management function (UDM)) being required, in response to a user plane security policy fetched from the management function (i.e., unified data management function (UDM)) being required, or a combination thereof.

In some embodiments, the method further comprises setting the security policy information to not supported, not enabled, not preferred, not needed, or a combination thereof in response to there being no aerial subscription available for an aerial vehicle corresponding to the aerial vehicle identifier, in response to a user plane security policy fetched from a management function (i.e., unified data management function (UDM)).

In various embodiments, the method further comprises providing the aerial vehicle authentication result during a protocol data unit session establishment procedure and the aerial system security requirement information along with the aerial vehicle identifier to a session management function in response to receiving a protocol data unit session establishment request from a user equipment with the aerial vehicle identifier.

In one embodiment, an apparatus comprises an access and mobility management function. The apparatus further comprises: a transmitter that transmits a request message to an uncrewed aerial system network function, a network exposure function, or a combination thereof, the request message comprising: an aerial vehicle identifier; a general public subscription identifier; and security policy information; a receiver that receives a response message from the uncrewed aerial system network function, the network exposure function, or the combination thereof, the response message comprising: the aerial vehicle identifier; the general public subscription identifier; an aerial vehicle authentication result, authorization result, or a combination thereof; and aerial system security requirement information; and a processor that stores the aerial system security requirement information together with the aerial vehicle identifier, the general public subscription identifier, and the aerial vehicle authentication result.

In certain embodiments, the processor sets the security policy information to supported, enabled, or a combination thereof in response to an aerial subscription user plane security policy fetched from a management function (i.e., unified data management function (UDM)) being required, in response to a user plane security policy fetched from the management function being required, or a combination thereof.

In some embodiments, the processor sets the security policy information to not supported, not enabled, not preferred, not needed, or a combination thereof in response to there being no aerial subscription available for an aerial vehicle corresponding to the aerial vehicle identifier, in response to a user plane security policy fetched from a management function (i.e., unified data management function (UDM)) being preferred, not needed, or a combination thereof.

In various embodiments, the transmitter transmits the aerial vehicle authentication result during a protocol data unit session establishment procedure and the aerial system security requirement information along with the aerial vehicle identifier to a session management function in response to receiving a protocol data unit session establishment request from a user equipment with the aerial vehicle identifier.

In one embodiment, a method of an uncrewed aerial system network function, a network exposure function, or a combination thereof comprises: receiving a first request message from an access and mobility management function, the first request message comprising: an aerial vehicle identifier; a general public subscription identifier; and security policy information; transmitting a second request message to an uncrewed aerial system service supplier, an uncrewed aerial system traffic management function, or a combination thereof, the second request message comprising: the aerial vehicle identifier; the general public subscription identifier; and the security policy information; receiving a second response message from the uncrewed aerial system service supplier, the uncrewed aerial system traffic management function, or the combination thereof, the second response message comprising: the aerial vehicle identifier; the general public subscription identifier; an aerial vehicle authentication result; and aerial system security requirement information; transmitting a first response message to the access and mobility management function, the first response message comprising: the aerial vehicle identifier; the general public subscription identifier; the aerial vehicle authentication result; and the aerial system security requirement information; and storing the aerial system security requirement information together with the aerial vehicle identifier, the general public subscription identifier, and the aerial vehicle authentication result.

In certain embodiments, the method further comprises providing the aerial vehicle authentication result during a protocol data unit session establishment procedure and the aerial system security requirement information along with the aerial vehicle identifier to a session management function in response to receiving an authentication request from the session management function.

In one embodiment, an apparatus comprises an uncrewed aerial system network function, a network exposure function, or a combination thereof. The apparatus further comprises: a receiver that receives a first request message from an access and mobility management function, the first request message comprising: an aerial vehicle identifier; a general public subscription identifier; and security policy information; a transmitter that transmits a second request message to an uncrewed aerial system service supplier, an uncrewed aerial system traffic management function, or a combination thereof, the second request message comprising: the aerial vehicle identifier; the general public subscription identifier; and the security policy information; and a processor, wherein: the receiver receives a second response message from the uncrewed aerial system service supplier, the uncrewed aerial system traffic management function, or the combination thereof, the second response message comprising: the aerial vehicle identifier; the general public subscription identifier; an aerial vehicle authentication result; and aerial system security requirement information; the transmitter transmits a first response message to the access and mobility management function, the first response message comprising: the aerial vehicle identifier; the general public subscription identifier; the aerial vehicle authentication result; and the aerial system security requirement information; and the processor stores the aerial system security requirement information together with the aerial vehicle identifier, the general public subscription identifier, and the aerial vehicle authentication result.

In certain embodiments, the transmitter transmits the aerial vehicle authentication result during a protocol data unit session establishment procedure and the aerial system security requirement information along with the aerial vehicle identifier to a session management function in response to receiving an authentication request from the session management function.

In one embodiment, a method of a session management function comprises: transmitting a third request message to an uncrewed aerial system network function, a network exposure function, or a combination thereof, the third request message comprising: an aerial vehicle identifier; a general public subscription identifier; and a data request indication; receiving a third response message from the uncrewed aerial system network function, the network exposure function, or the combination thereof, the third response message comprising: the aerial vehicle identifier; the general public subscription identifier; an aerial vehicle authentication result; and aerial system security requirement information; in response to receiving the aerial vehicle authentication result, determining to establish a protocol data unit session and skipping aerial vehicle authentication; storing the aerial system security requirement information together with the aerial vehicle identifier, the general public subscription identifier, the aerial vehicle authentication result, and the aerial system security requirement information; and applying user plane security based on the aerial system security requirement information.

In certain embodiments, the method further comprises receiving the third response without sending the third request message in response to the uncrewed aerial system network function, the network exposure function, or the combination thereof comprising an access and mobility management function.

In some embodiments, the method further comprises receiving the third response in response to the uncrewed aerial system network function, the network exposure function, or the combination thereof comprising an access and mobility management system, the access and mobility management function receiving a protocol data unit session establishment request having the aerial vehicle identifier, and the access and mobility management system has the aerial vehicle identifier with the aerial vehicle authentication result, and the aerial system security requirement information.

In various embodiments, the third request message is an authentication data request or an authentication request message.

In one embodiment, the third response message is an authentication data response or authentication response message.

In certain embodiments, the third response message comprises a data not available indication.

In some embodiments, the method further comprises determining to invoke aerial vehicle authentication if a data not available indication is received or if no aerial vehicle authentication result and security requirement information is received from a network function.

In one embodiment, an apparatus comprises a session management function. The apparatus further comprises: a transmitter that transmits a third request message to an uncrewed aerial system network function, a network exposure function, or a combination thereof, the third request message comprising: an aerial vehicle identifier; a general public subscription identifier; and a data request indication; a receiver that receives a third response message from the uncrewed aerial system network function, the network exposure function, or the combination thereof, the third response message comprising: the aerial vehicle identifier; the general public subscription identifier; an aerial vehicle authentication result; and aerial system security requirement information; a processor that: in response to receiving the aerial vehicle authentication result, determines to establish a protocol data unit session and skipping aerial vehicle authentication; stores the aerial system security requirement information together with the aerial vehicle identifier, the general public subscription identifier, the aerial vehicle authentication result, and the aerial system security requirement information; and applies user plane security based on the aerial system security requirement information.

In certain embodiments, the receiver receives the third response without sending the third request message in response to the uncrewed aerial system network function, the network exposure function, or the combination thereof comprising an access and mobility management function.

In some embodiments, the receiver receives the third response in response to the uncrewed aerial system network function, the network exposure function, or the combination thereof comprising an access and mobility management system, the access and mobility management function receiving a protocol data unit session establishment request having the aerial vehicle identifier, and the access and mobility management system has the aerial vehicle identifier with the aerial vehicle authentication result, and the aerial system security requirement information.

In various embodiments, the third request message is an authentication data request or an authentication request message.

In one embodiment, the third response message is an authentication data response or authentication response message.

In certain embodiments, the third response message comprises a data not available indication.

In some embodiments, the processor determines to invoke aerial vehicle authentication if a data not available indication is received or if no aerial vehicle authentication result and security requirement information is received from a network function.

In one embodiment, a method of an uncrewed aerial system service supplier, an uncrewed aerial system traffic management function, or a combination thereof comprises: receiving a request message from an uncrewed aerial system network function, a network exposure function, or a combination thereof, the request message comprising: an aerial vehicle identifier; a general public subscription identifier; and security policy information; transmitting a response message to the uncrewed aerial system network function, the network exposure function, or the combination thereof, the response message comprising: the aerial vehicle identifier; the general public subscription identifier; an aerial vehicle authentication result; and aerial system security requirement information; and storing the aerial system security requirement information together with the aerial vehicle identifier, the general public subscription identifier, and the aerial vehicle authentication result.

In certain embodiments, the method further comprises setting the aerial system security requirement information as required based on: whether the security policy information is supported, enabled, or a combination thereof received from the uncrewed aerial system network function, the network exposure function, or the combination thereof; whether an uncrewed aerial system service supplier, an uncrewed aerial system traffic management function, or a combination thereof determines not to apply end-to-end security for session data, user plane data, or a combination thereof; or a combination thereof.

In some embodiments, the method further comprises transmitting a cause value indicating that end-to-end security is not applicable, not supported, or a combination thereof.

In various embodiments, the method further comprises setting the aerial system security requirement information as not required based on: whether the security policy information is not supported, not enabled, not needed, not preferred, or a combination thereof received from the uncrewed aerial system network function, the network exposure function, or the combination thereof; whether an uncrewed aerial system service supplier, an uncrewed aerial system traffic management function, or a combination thereof receives no security policy information during aerial vehicle authentication and/or authorization; whether the uncrewed aerial system service supplier, the uncrewed aerial system traffic management function, or the combination thereof determines to apply end-to-end security for session data, user plane data, or a combination thereof; or some combination thereof.

In one embodiment, the method further comprises transmitting a cause value indicating that end-to-end security is applicable, supported or a combination thereof.

In certain embodiments, if the security policy information is supported, enabled or a combination thereof is received from the uncrewed aerial system network function, the network exposure function, or the combination thereof, then an uncrewed aerial system service supplier, an uncrewed aerial system traffic management function, or a combination thereof determines to skip end-to-end security, sets the aerial system security requirement information as required, and sets a cause value as end-to-end security not applicable, not supported, or a combination thereof.

In some embodiments, if the security policy information is not supported, not enabled, not needed, not preferred, or a combination thereof is received from the uncrewed aerial system network function, the network exposure function, or the combination thereof, then an uncrewed aerial system service supplier, an uncrewed aerial system traffic management function, or a combination thereof determines to activate end-to-end security, sets the aerial system security requirement information as not required, and sets a cause value as end-to-end security being applicable, supported, or a combination thereof.

In one embodiment, an apparatus comprises an uncrewed aerial system service supplier, an uncrewed aerial system traffic management function, or a combination thereof. The apparatus further comprises: a receiver that receives a request message from an uncrewed aerial system network function, a network exposure function, or a combination thereof, the request message comprising: an aerial vehicle identifier; a general public subscription identifier; and security policy information; a transmitter that transmits a response message to the uncrewed aerial system network function, the network exposure function, or the combination thereof, the response message comprising: the aerial vehicle identifier; the general public subscription identifier; an aerial vehicle authentication result; and aerial system security requirement information; and a processor that stores the aerial system security requirement information together with the aerial vehicle identifier, the general public subscription identifier, and the aerial vehicle authentication result.

In certain embodiments, the processor sets the aerial system security requirement information as required based on: whether the security policy information is supported, enabled, or a combination thereof received from the uncrewed aerial system network function, the network exposure function, or the combination thereof; whether an uncrewed aerial system service supplier, an uncrewed aerial system traffic management function, or a combination thereof determines not to apply end-to-end security for session data, user plane data, or a combination thereof; or a combination thereof.

In some embodiments, the transmitter transmits a cause value indicating that end-to-end security is not applicable, not supported, or a combination thereof.

In various embodiments, the processor sets the aerial system security requirement information as not required based on: whether the security policy information is not supported, not enabled, not needed, not preferred, or a combination thereof received from the uncrewed aerial system network function, the network exposure function, or the combination thereof; whether an uncrewed aerial system service supplier, an uncrewed aerial system traffic management function, or a combination thereof receives no security policy information during aerial vehicle authentication and/or authorization; whether the uncrewed aerial system service supplier, the uncrewed aerial system traffic management function, or the combination thereof determines to apply end-to-end security for session data, user plane data, or a combination thereof; or some combination thereof.

In one embodiment, the transmitter transmits a cause value indicating that end-to-end security is applicable, supported or a combination thereof.

In certain embodiments, if the security policy information is supported, enabled or a combination thereof is received from the uncrewed aerial system network function, the network exposure function, or the combination thereof, then an uncrewed aerial system service supplier, an uncrewed aerial system traffic management function, or a combination thereof determines to skip end-to-end security, sets the aerial system security requirement information as required, and sets a cause value as end-to-end security not applicable, not supported, or a combination thereof.

In some embodiments, if the security policy information is not supported, not enabled, not needed, not preferred, or a combination thereof is received from the uncrewed aerial system network function, the network exposure function, or the combination thereof, then an uncrewed aerial system service supplier, an uncrewed aerial system traffic management function, or a combination thereof determines to activate end-to-end security, sets the aerial system security requirement information as not required, and sets a cause value as end-to-end security being applicable, supported, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function, the apparatus comprising:
at least one memory; and
at least one processor coupled with the at least one memory and configured to cause the apparatus to:
transmit a request message to an uncrewed aerial system network function, a network exposure function, or a combination thereof, wherein the request message comprises an aerial vehicle identifier (ID), a public subscription ID, and security policy information;
receive a response message from the uncrewed aerial system network function, the network exposure function, or the combination thereof, wherein the response message comprises the aerial vehicle ID, the public subscription ID, one or more of an aerial vehicle authentication result or authorization result, and aerial system security requirement information; and
store the aerial system security requirement information, the aerial vehicle ID, the public subscription ID, and the aerial vehicle authentication result.

2. The apparatus of claim 1, wherein the at least one processor is configured to cause the apparatus to set the security policy information to supported, enabled, or a combination thereof in response to an aerial subscription user plane security policy fetched from a management function, being required, in response to a user plane security policy fetched from the management function, being required, or a combination thereof.

3. The apparatus of claim 1, wherein the at least one processor is configured to cause the apparatus to set the security policy information to not supported, not enabled, not preferred, not needed, or a combination thereof in response to there being no aerial subscription available for an aerial vehicle corresponding to the aerial vehicle ID, in response to a user plane security policy fetched from a management function, being preferred, not needed, or a combination thereof.

4. The apparatus of claim 1, wherein the at least one processor is configured to cause the apparatus to transmit the aerial vehicle authentication result during a protocol data unit session establishment procedure and the aerial system security requirement information along with the aerial vehicle ID to a session management function in response to receiving a protocol data unit session establishment request from a user equipment (UE) with the aerial vehicle ID.

5. An apparatus for performing a network function, the apparatus comprising:
at least one memory; and
at least one processor coupled with the at least one memory and configured to cause the apparatus to:
receive a first request message from an access and mobility management function, wherein the first request message comprises an aerial vehicle identifier (ID), a public subscription ID, and security policy information;
transmit a second request message to an uncrewed aerial system service supplier, an uncrewed aerial system traffic management function, or a combination thereof, wherein the second request message comprises the aerial vehicle ID, the public subscription ID, and the security policy information;
receive a second response message from the uncrewed aerial system service supplier, the uncrewed aerial system traffic management function, or the combination thereof, wherein the second response message comprises the aerial vehicle ID, the public subscription ID, an aerial vehicle authentication result, and aerial system security requirement information;
transmit a first response message to the access and mobility management function, wherein the first response message comprises the aerial vehicle ID. the public subscription ID, the aerial vehicle authentication result, and the aerial system security requirement information; and
store the aerial system security requirement information, the aerial vehicle ID, the public subscription ID, and the aerial vehicle authentication result.

6. The apparatus of claim 5, wherein the at least one processor is configured to cause the apparatus to transmit the aerial vehicle authentication result during a protocol data unit session establishment procedure and the aerial system security requirement information along with the aerial vehicle ID to a session management function in response to receiving an authentication request from the session management function.

7. A method of performing a network function, the method comprising:
transmitting a third request message to an uncrewed aerial system network function, a network exposure function, or a combination thereof, wherein the third request message comprises an aerial vehicle identifier (ID), a public subscription ID, and a data request indication;
receiving a third response message from the uncrewed aerial system network function, the network exposure function, or the combination thereof, wherein the third response message comprises the aerial vehicle ID, the public subscription ID, an aerial vehicle authentication result, and aerial system security requirement information;
in response to receiving the aerial vehicle authentication result, determining to establish a protocol data unit session and skipping aerial vehicle authentication;
storing the aerial system security requirement information, the aerial vehicle ID, the public subscription ID, the aerial vehicle authentication result, and the aerial system security requirement information; and
applying user plane security based on the aerial system security requirement information.

8. The method of claim 7, further comprising receiving the third response without sending the third request message in response to the uncrewed aerial system network function, the network exposure function, or the combination thereof comprising an access and mobility management function.

9. The method of claim 7, further comprising receiving the third response in response to the uncrewed aerial system network function, the network exposure function, or the combination thereof comprising an access and mobility management system, the access and mobility management function receiving a protocol data unit session establishment request having the aerial vehicle ID, and the access and mobility management system has the aerial vehicle ID with the aerial vehicle authentication result, and the aerial system security requirement information.

10. The method of claim 7, wherein the third request message is an authentication data request or an authentication request message.

11. The method of any of claim 7, wherein the third response message is an authentication data response or authentication response message.

12. The method of any of claim 7, wherein the third response message comprises a data not available indication.

13. The method of any of claim 7, further comprising determining to invoke aerial vehicle authentication if a data not available indication is received or if no aerial vehicle authentication result and security requirement information is received from a network function.

14. A method of performing a network function, the method comprising:
receiving a request message from an access and mobility management function, wherein the request message comprises an aerial vehicle identifier (ID), a public subscription ID, and security policy information;
transmitting a response message to an uncrewed aerial system network function, a network exposure function, or a combination thereof, wherein the response message comprises the aerial vehicle ID, the public subscription ID, an aerial vehicle authentication result, and aerial system security requirement information; and
storing the aerial system security requirement information, the aerial vehicle ID, the public subscription ID, and the aerial vehicle authentication result.

15. The method of claim 14, further comprising setting the aerial system security requirement information as required based on:
whether the security policy information is supported, enabled, or a combination thereof received from the uncrewed aerial system network function, the network exposure function, or the combination thereof;
whether an uncrewed aerial system service supplier, an uncrewed aerial system traffic management function, or a combination thereof determines not to apply end-to-end security for session data, user plane data, or a combination thereof;
or a combination thereof.

16. The method of claim 15, further comprising transmitting a cause value indicating that end-to-end security is not applicable, not supported, or a combination thereof.

17. The method of claim 14, further comprising setting the aerial system security requirement information as not required based on:
whether the security policy information is not supported, not enabled, not needed, not preferred, or a combination thereof received from the uncrewed aerial system network function, the network exposure function, or the combination thereof;
whether an uncrewed aerial system service supplier, an uncrewed aerial system traffic management function, or a combination thereof receives no security policy information during aerial vehicle authentication and/or authorization;
whether the uncrewed aerial system service supplier, the uncrewed aerial system traffic management function, or the combination thereof determines to apply end-to-end security for session data, user plane data, or a combination thereof;
or combination thereof.

18. The method of claim 17, further comprising transmitting a cause value indicating that end-to-end security is applicable, supported or a combination thereof.

19. The method of any of claim 14, wherein, if the security policy information is supported, enabled or a combination thereof is received from the uncrewed aerial system network function, the network exposure function, or the combination thereof, then an uncrewed aerial system service supplier, an uncrewed aerial system traffic management function, or a combination thereof determines to skip end-to-end security, sets the aerial system security requirement information as required, and sets a cause value as end-to-end security not applicable, not supported, or a combination thereof.

20. The method of any of claim 14, wherein, if the security policy information is not supported, not enabled, not needed, not preferred, or a combination thereof is received from the uncrewed aerial system network function, the network exposure function, or the combination thereof, then an uncrewed aerial system service supplier, an uncrewed aerial system traffic management function, or a combination thereof determines to activate end-to-end security, sets the aerial system security requirement information as not required, and sets a cause value as end-to-end security being applicable, supported, or a combination thereof.
